(19) United States
(12) Patent Application Publication
(10) Pub. No.: US 2006/0044970 A1
(43) Pub. Date: Mar. 2, 2006

(54) Disc player and method of reproducing information on disc

(76) Inventor: Yoichi Watanabe, Iwaki-city (JP)

Correspondence Address: BRINKS HOFER GILSON & LIONE, P.O. BOX 10395, CHICAGO, IL, 60610, US

(21) Appl. No.: 11/201,403

(22) Filed: Aug. 10, 2005

(30) Foreign Application Priority Data
Aug. 12, 2004 (JP) 2004-235318

(51) Int. Cl. G11B 5/09

(52) U.S. Cl. 369/47.12; 369/47.1; 369/53.1

(57) ABSTRACT

A disc player reproduces information in a plurality of blocks sequentially provided on a disc. The disc player includes an optical pickup reading the information recorded on the disc; an optical-pickup moving unit moving the optical pickup; and a controller controlling the optical pickup moving unit. When the optical pickup is not able to read the information recorded on the disc, the controller controls the moving unit to move the optical pickup to the head of a block subsequent to the block where the optical pickup cannot read the information if the block to which the optical pickup reaches in a predetermined time is different from the block where the optical pickup cannot read the information recorded on the disc.

### BACKGROUND OF THE INVENTION

1. Field of the Invention

The present invention relates to a disc player reproducing music or video information recorded on a disc and a method of reproducing music or video information recorded on a disc.

2. Description of the Related Art

Disc players that reproduce information on discs (for example, optical discs) having content, such as music information or video information, recorded thereon generally perform signal processing, such as error correction, for signals read by optical pickups while performing tracking in which the optical pickups follow the recording tracks on the rotating discs in order to reproduce the content.

Although read errors can occur because of scratches, etc. on the recording tracks, it is possible to restore minor errors by the error correction.

However, if deep scratches that cannot be restored by the error correction are made on the recording tracks, a tracking servo causing the optical pickups to follow the recording tracks does not operate normally, possibly causing a so-called locked loop, in which the same positions are repeatedly traced on the recording tracks.

In order to avoid such a locked loop, a technology of detecting a scratch on a recording track from a reduction in the level of a signal read from an optical pickup and jumping part of the recording track if the scratch is detected on the recording track is disclosed in Japanese Unexamined Patent Application Publication No. 7-98871 (Patent Document 1).

Another technology in a disc player is disclosed in Japanese Unexamined Patent Application Publication No. 11-328686 (Patent Document 2). With this technology, when the current position of an optical pickup is moved backward because of a scratch on the disc (when it is determined that the optical pickup moves toward the inner side of the disc where the recording track runs from the inner side of the disc to the outer side thereof), the optical pickup is caused to perform a track jump while increasing the number of tracks such that the optical pickup moves toward the outer side of the disc. When the number of track jumps exceeds a predetermined number of times, the optical pickup is forcedly fed toward the outer side of the disc for a predetermined time to continue the reproduction of information on the disc.

When a scratch or the like is made on the disc, the optical pickup is moved so as to jump part of the recording track in the technology disclosed in Patent Document 1, and the optical pickup is forcedly moved for the predetermined time in the technology disclosed in Patent Document 2. Accordingly, the optical pickup can be moved across music tracks, which are formed by dividing music information recorded on the disc for every tune, or across chapters, which are formed by dividing video information recorded on the disc for every predetermined unit. Since moving the optical pickup in these manners inhibits reproduction of the head of the destination tune or chapter, there is a problem in that even a tune or chapter having no scratch is reproduced with the head of the tune or chapter being skipped, thus hindering a user from comfortably listening to or watching the music information or video information.

### SUMMARY OF THE INVENTION

In order to resolve the above problem, it is desirable to reproduce the head of a block, such as a tune or a chapter, as much as possible when the information on a disc having a scratched portion is reproduced with the scratched portion being skipped.

According to an embodiment, the present invention provides a disc player that reproduces information in a plurality of blocks sequentially provided on a disc. The disc player includes an optical pickup operable to read the information recorded on a first block of the disc; a moving unit operable to move the optical pickup for a predetermined period of time when the optical pickup is no longer able to read the information recorded on the first block; and a controller operable to direct the moving unit to move the optical pickup to the head of a second block subsequent to the first block if the portion of the disc to which the optical pickup will reach after being moved for the predetermined time is within the second block.

According to another embodiment, the present invention provides a method of reproducing information in a plurality of blocks sequentially provided on a disc. The method includes determining a position where an optical pickup will reach in a predetermined time when the optical pickup is not able to read the information recorded on a first block of the disc; determining whether the position is beyond the head of a second block subsequent to the first block; and moving the optical pickup to the head of the second block if it is determined that the position is beyond the head of the second block.

According to another embodiment, the present invention provides a method of reproducing information in a plurality of blocks sequentially provided on a disc. The method includes moving an optical pickup by a distance corresponding to a predetermined time when the optical pickup is not able to read the information recorded on a unreadable portion of the disc; determining whether the block to which the optical pickup has been moved to includes the unreadable portion of the disc; and moving the optical pickup to the head of a the block to which the optical pickup has been moved if it is determined that the block does not include the unreadable portion of the disc.

According to the embodiments of the present invention, since the optical pickup is moved to the head of the destination block to continue the reproduction of the information when the destination block to which the optical pickup is moved so as to skip a scratched portion is different from the block before the movement, the entire block having no scratch can be reproduced. Accordingly, a user can comfortably listen to or watch the information even on the disc having a scratched portion.

### BRIEF DESCRIPTION OF THE DRAWINGS

FIG. 1 is a block diagram showing an example of the structure of a disc player according to first and second embodiments;

FIG. 2 shows an example of the data structure of a subcode;

FIG. 3 shows an example of the data structure of a TOC;

FIGS. 4A to 4C show an example of the method of reproducing information on the disc in the disc player according to the first embodiment;

FIG. 5 is a flowchart showing the operation of the disc player and the method of reproducing the information on the optical disc in the disc player, according to the first embodiment;

FIGS. 6A to 6C show an example of the method of reproducing information on the disc in the disc player according to the second embodiment;

FIG. 7 is a flowchart showing the operation of the disc player and the method of reproducing the information on the optical disc in the disc player, according to the second embodiment;

FIGS. 8A and 8B show a modified example of the method of reproducing the information on the disc in the disc player according to the first embodiment; and

FIGS. 8A to 9D′ show an example of the method of reproducing the information on the disc when a scratch is made at the destination of the optical pickup in the disc player according to the first and second embodiments.

FIGS. 9A to 9D′ show an example of the method of reproducing the information on the disc when a scratch is made at the destination of the optical pickup in the disc player according to the first and second embodiments.

### DESCRIPTION OF THE PREFERRED EMBODIMENTS

First Embodiment

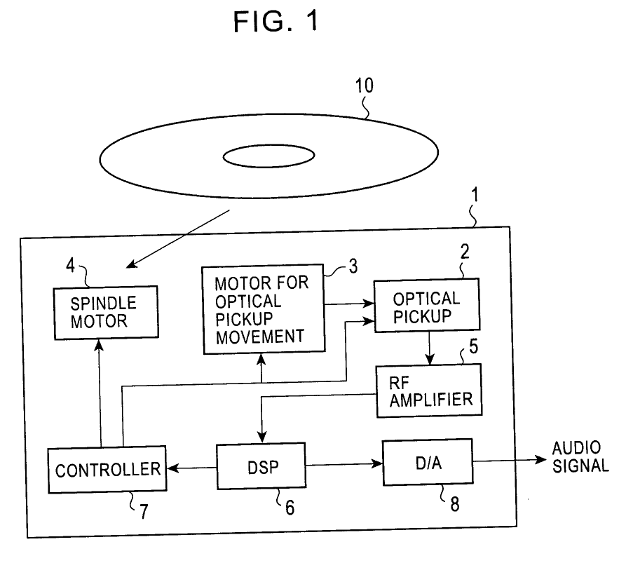

A first embodiment of the present invention will be described below with reference to the attached drawings. FIG. 1 is a block diagram showing an example of the structure of a disc player 1 according to the first embodiment. Referring to FIG. 1, an optical disc 10 (for example, a compact disc (CD)) has a scratch on the signal recording surface having information recorded thereon. The information recorded on the optical disc 10 includes music information and subcodes. The music information recoded on the optical disc 10 is composed of a plurality of music tracks (for example, tunes). The plurality of music tracks have respective music track numbers. The plurality of music tracks are recorded on a spiral recording track running from the inner side of the optical disc 10 to the outer side thereof in the order of the music track numbers. A lead-in area is provided at the most inner side and a lead-out area is provided at the most outer side. The music tracks correspond to blocks described in the claims.

The recording track has subcodes recorded thereon, in addition to the plurality of music tracks. The subcodes have eight types P, Q, R, S, T, U, V, and W. Among these types of subcodes, the P subcode is used for locating the start of a tune, the Q subcode is used for time data of the tune, and the remaining subcodes R to W are used for other data. One subcode is composed of data corresponding to one second.

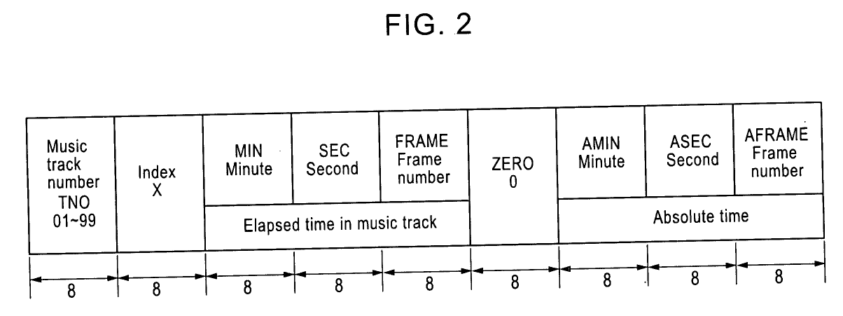

Each subcode has the data structure, for example, shown in FIG. 2. Referring to FIG. 2, “Music track number TNO” indicates the music track number of a position where the subcode is recorded and is set to any value of “00” to “99” and “AA”. The values “01” to “99” denote the numbers of music tracks on which music information is actually recorded. The music track is the lead-in area when the music track number TNO has a value of “00”, and the music track is the lead-out area when the music track number TNO has a value of “AA”. “Index” indicates the index of a position where the subcode is recorded and is set to any value of “00” to “99”. Segmentation of the music track forms the indexes. “MIN (Minute)”, “SEC (Second)”, and “FRAME (Frame number)” indicate values representing the elapsed time during which the tune advances from the head of the tune (music track) to the position where the subcode is recorded. “ZERO” has a value of “0”, which is represented as “00000000” in eight bits.

“AMIN”, “ASEC”, and “AFRAME” indicate values representing the absolute time during which the tune advances from the head (excluding the lead-in area) of the optical disc 10 to the position where the subcode is recorded. The “AMIN” has any value of “0” to “74” and the “ASEC” has any value of “0” to “59” because the maximum recording time on the optical disc 10 is 74 minutes. The “AFRAME” has any value of “0” to “74” and 75 frames corresponds to one second.

The lead-in area of the optical disc 10 has a table of contents (TOC) of the music information recorded on the optical disc 10.

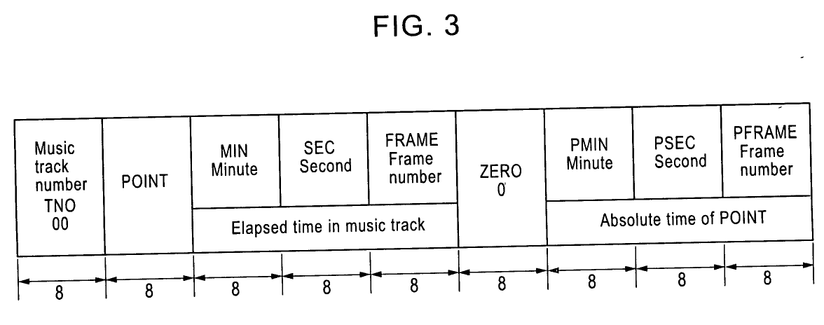

The TOC has the data structure, for example, as shown in FIG. 3. Referring to FIG. 3, “Music track number TNO” indicates a music track number of a position where the TOC is recorded. Since the TOC is recorded in the lead-in area, the “Music track number TNO” has a value of “00”. “POINT” indicates a music track number on the optical disc 10 and has any value of “00” to “99”, “A0”, “A1”, and “A2”. “MIN (Minute)”, “SEC (Second)”, and “FRAME (Frame number)” indicate values representing the elapsed time during which the tune advances from the head of the tune (music track) to the position where the TOC is recorded. “ZERO” has a value of “0”, which is represented as “00000000” in eight bits.

“PMIN”, “PSEC”, and “PFRAME” have different meanings depending on the value of the “POINT”. When the “POINT” has any value of “00” to “99”, the “PMIN”, “PSEC”, and “PFRAME” indicate values representing the absolute time during which the tune advances from the head (excluding the lead-in area) of the optical disc 10 to the head of the music track indicated by the value in the “POINT”. The “PMIN” has any value of “0” to “74” and the “PSEC” has any value of “0” to “59”. The “PFRAME” has any value of “0” to “74”.

When the “POINT” has a value of “A0”, the “IPMIN” indicates the first music track number on the optical disc 10, and both the “PSEC” and “PFRAME” have a value of “0”. When the “POINT” has a value of “A1”, the “PMIN” indicates the last music track number on the optical disc 10, and both the “PSEC” and “PFRAME” has a value of “0”. When the “POINT” has a value of “A2”, the “PMIN”, “PSEC”, and “PFRAME” indicate values representing the absolute time when the lead-out area starts.

Referring back to FIG. 1, an optical pickup 2 emits a laser beam with which information recorded on the optical disc 10 is reproduced and receives reflected light from the optical disc 10 to produce a reproduction signal. When the optical disc 10 is loaded in the disc player 1, the optical pickup 2 reads a TOC recorded in the lead-in area, which is provided at the most inner side of the optical disc 10. A motor 3 for optical pickup movement (corresponding to an optical-pickup moving unit in the claims) moves the position where the optical pickup 2 emits the laser beam in the radial direction of the optical disc 10 (hereinafter referred to as “moves the optical pickup 2”). A spindle motor 4 rotates and drives the optical disc 10.

A radio-frequency (RF) amplifier 5 receives the reproduction signal and the TOC from the optical pickup 2 to generate an RF signal. A digital signal processor (DSP) 6 receives the RF signal from the RF amplifier 5 to binarize the RF signal as digital data and to perform error correction for the binarized digital data. If the DSP 6 cannot perform the error correction for the digital data, the DSP 6 determines that the optical pickup 2 cannot read the information recorded on the optical disc 10 because of a scratch on the optical disc 10 and outputs a read error signal. The DSP 6 separates the digital data subjected to the error correction into a digital audio signal and a synchronization signal and outputs the separated signals. The synchronization signal includes the content of the TOC.

A controller 7 receives the synchronization signal and the read error signal from the DSP 6. The controller 7 performs tracking and focusing for an actuator (not shown) of the optical pickup 2 based on the synchronization signal received from the DSP 6. The controller 7 also rotates and controls the spindle motor 4 based on the synchronization signal received from the DSP 6.

Furthermore, the controller 7 controls the motor 3 for optical pickup movement based on the synchronization signal and the read error signal received from the DSP 6. When the controller 7 does not receive the read error signal from the DSP 6, that is, when the optical pickup 2 can read the information recorded on the optical disc 10, the motor 3 for optical pickup movement moves the optical pickup 2 in the radial direction such that the optical pickup 2 follows the recording track on the optical disc 10.

When the controller 7 receives the read error signal from the DSP 6, the controller 7 controls the motor 3 for optical pickup movement to move the optical pickup 2 toward the outer side of the optical disc 10 by a predetermined length of track jump. The predetermined length of track jump indicates, for example, the radial distance of the optical disc 10 when the controller 7 skips the information on the recording track by the distance corresponding to a predetermined time, for example, three to 10 seconds.

Before actually moving the optical pickup 2, the controller 7 determines whether the music track that is being reproduced is different from the music track to which the optical pickup 2 is to be moved (the destination music track) and whether the optical pickup 2 is to be moved beyond the head of the destination music track. If the controller 7 determines that the music track that is being reproduced is different from the destination music track and that the optical pickup 2 is to be moved beyond the head of the destination music track, the controller 7 controls the motor 3 for optical pickup movement to move the optical pickup 2 to the head of the destination music track.

Specifically, after the optical disc 10 is loaded in the disc player 1, the controller 7 controls the motor 3 for optical pickup movement to move the optical pickup 2 to the lead-in area of the optical disc 10. The optical pickup 2 reproduces the information in the lead-in area of the optical disc 10 to acquire the TOC. The acquired TOC is supplied to the controller 7 through the RF amplifier 5 and the DSP 6.

The controller 7 acquires from the TOC the number of music tracks, the music track numbers, the absolute time of the head of each music track on the optical disc 10 loaded in the disc player 1.

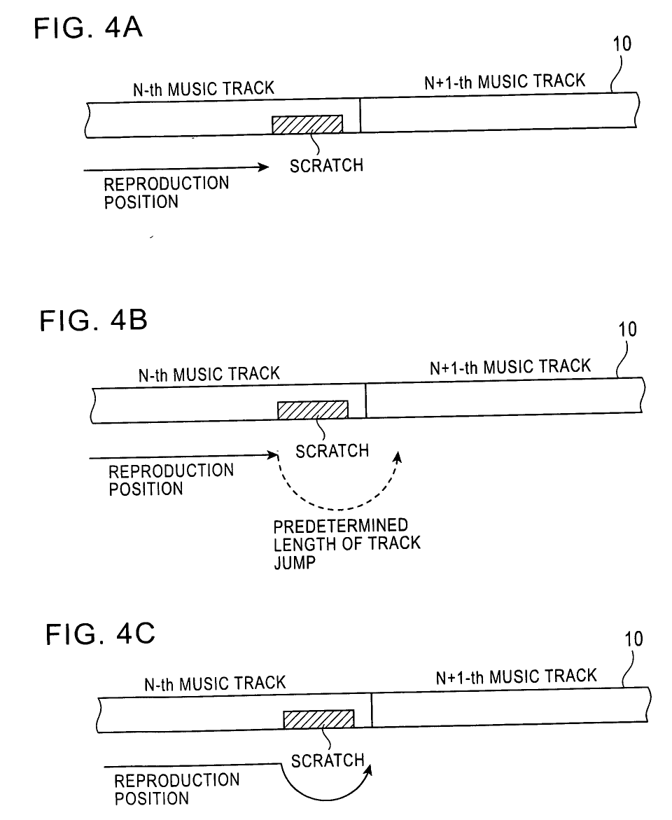

When the optical pickup 2 reproduces the n−th (n denotes a integer of one or more) music track, as shown in FIG. 4a, the controller 7 determines the absolute time of the position where the optical pickup 2 is currently reproducing the information from the subcodes and so on. The controller 7 recognizes that a scratch is made on the optical disc 10 from the read error signal received from the DSP 6.

When the controller 7 recognizes that the scratch is made on the optical disc 10, the controller 7 sets a destination of the optical pickup 2 to be moved toward the outer side of the optical disc 10 by a predetermined length of track jump in order to avoid the scratch made on the optical disc 10, as shown in FIG. 4B. The controller 7, then, determines the absolute time of the set destination of the optical pickup 2. For example, the absolute time of the set destination of the optical pickup 2 is determined by adding the time corresponding to the predetermined length of track jump to the absolute time of the position where the optical pickup 2 is currently reproducing the information.

The controller 7 refers to the acquired TOC and compares the absolute time of the current reproduction position with the absolute time of the head of each music track to determine the music track number (n−th music track) currently being reproduced. In addition, the controller 7 compares the absolute time of the set destination of the optical pickup 2 with the absolute time of the head of each music track to determine whether the set destination of the optical pickup 2 is beyond the head of the music track number (n+1−th music track) subsequent to the music track number (n−th music track) currently being reproduced.

If the controller 7 determines that the set destination of the optical pickup 2 is beyond the head of the n+1−th music track subsequent to the n−th music track currently being reproduced, the controller 7 refers to the TOC to determine the absolute time of the head of the n+1−th music track. The controller 7 controls the motor 3 for optical pickup movement to move the optical pickup 2 to the position corresponding to the determined absolute time (the head of the n+1−th music track), as shown in FIG. 4C.

Referring back again to FIG. 1, a digital-analog (D/A) converter 8 receives the digital audio signal supplied from the DSP 6, converts the received digital audio signal into analog audio information, and outputs the converted analog audio information.

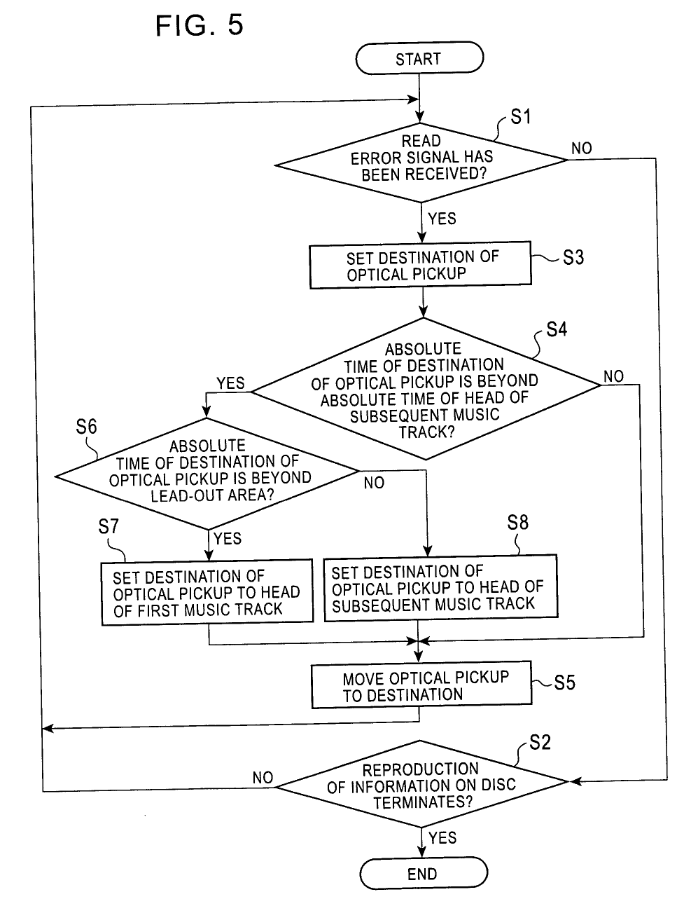

The operation of the disc player 1 and a method of reproducing information on the optical disc 10 in the disc player 1, according to the first embodiment, will now be described. FIG. 5 is a flowchart showing the operation of the disc player 1 and the method of reproducing information on the optical disc 10 in the disc player 1, according to the first embodiment. In Step S1, with the information on the optical disc 10 being reproduced in the disc player 1, the controller 7 determines whether a read error signal is received from the DSP 6. If the controller 7 determines that the read error signal is not received from the DSP 6 (the determination is negative in Step S1), then in Step S2, the controller 7 determines whether the reproduction of the information on the optical disc 10 terminates in the disc player 1.

If the controller 7 determines that the reproduction of the information on the optical disc 10 terminates (the determination is affirmative in Step S2), the process ends. If the controller 7 determines that the reproduction of the information on the optical disc 10 does not terminate (the determination is negative in Step S2), the controller 7 goes back to Step S1.

If the controller 7 determines that the read error signal is received from the DSP 6 (the determination is affirmative in Step S1), then in Step S3, the controller 7 sets a destination of the optical pickup 2 to be moved toward the outer side of the optical disc 10 by a predetermined length of track jump.

In Step S4, the controller 7 determines whether the absolute time of the set destination of the optical pickup 2 is beyond the absolute time of the head of the subsequent music track. If the controller 7 determines that the absolute time of the set destination of the optical pickup 2 is not beyond the absolute time of the head of the subsequent music track (the determination is negative in Step S4), then in Step S5, the controller 7 controls the motor 3 for optical pickup movement to move the optical pickup 2 to the destination set in Step S3. The controller 7 goes back to Step S1 while continuing the reproduction of the information on the optical disc 10.

If the controller 7 determines that the absolute time of the set destination of the optical pickup 2 is beyond the absolute time of the head of the subsequent music track (the determination is affirmative in Step S4), then in Step S6, the controller 7 determines whether the absolute time of the set destination of the optical pickup 2 is beyond the absolute time of the start position of the lead-out area. If the controller 7 determines that the absolute time of the set destination of the optical pickup 2 is beyond the absolute time of the start position of the lead-out area (the determination is affirmative in Step S6), then in Step S7, the controller 7 sets the destination of the optical pickup 2 to the head of the first music track because the information in the lead-out area cannot be reproduced. In Step S5, the controller 7 controls the motor 3 for optical pickup movement to move the optical pickup 2 to the destination set in Step S7. The controller 7 goes back to Step S1 while continuing the reproduction of the information on the optical disc 10.

If the controller 7 determines that the absolute time of the set destination of the optical pickup 2 is not beyond the absolute time of the start position of the lead-out area (the determination is negative in Step S6), then in Step S8, the controller 7 sets the destination of the optical pickup 2 to the head of the subsequent music track. In Step S5, the controller 7 controls the motor 3 for optical pickup movement to move the optical pickup 2 to the destination set in Step S8. The controller 7 goes back to Step S1 while continuing the reproduction of the information on the optical disc 10.

As described above in detail, according to the first embodiment, when the controller 7 receives the read error signal, the controller 7 sets a position where the optical pickup 2 reaches in a predetermined time and determines whether the set position is beyond the head of the music track subsequent to the music track being currently reproduced. If the controller 7 determines that the set position is beyond the head of the subsequent music track, the controller 7 controls the motor 3 for optical pickup movement to move the optical pickup 2 to the head of the subsequent music track. Accordingly, when the optical pickup 2 is moved to the subsequent music track where the information on the optical disc 10 is reproduced with a scratched portion being skipped, the information is reproduced from the head of the subsequent music track. As a result, the entire music track having no scratch can be reproduced, thus allowing a user to comfortably listen to the music information even on the disc having a scratch or the like.

According to the first embodiment, when the information on the optical disc 10 is reproduced with a scratched portion being skipped, the controller 7 determines whether the optical pickup 2 is to be moved beyond the head of the subsequent music track without actually moving the optical pickup 2. Accordingly, it is possible to reduce the load on the motor 3 for optical pickup movement.

Second Embodiment

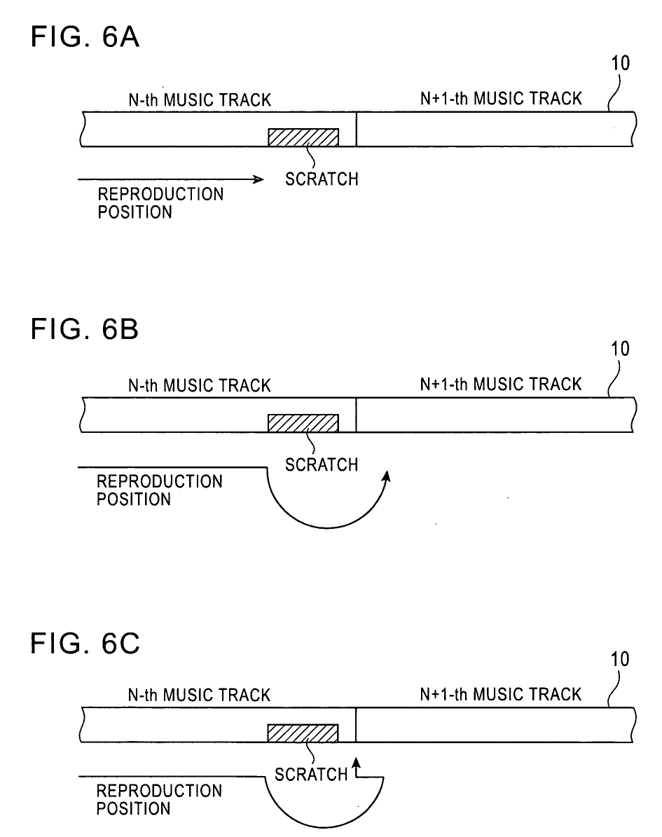

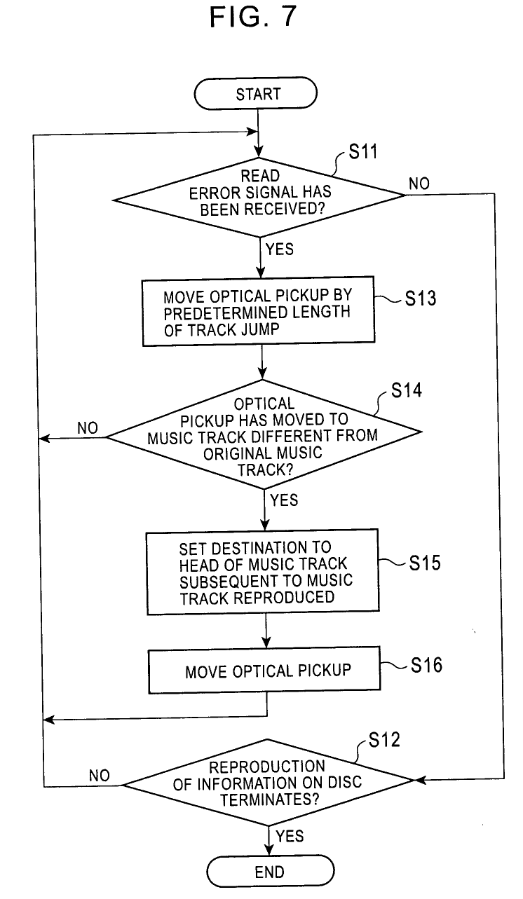

A second embodiment of the present invention will be described below with reference to the attached drawings. Since the entire structure of a disc player 1 according to the second embodiment is similar to that of the disc player 1 in FIG. 1, a detailed description is omitted herein. However, the disc player 1 according to the second embodiment operates in a manner shown in FIGS. 6 and 7.

According to the second embodiment, when the controller 7 receives the read error signal from the DSP 6, the controller 7 controls the motor 3 for optical pickup movement to actually move the optical pickup 2 toward the outer side of the optical disc 10 by a predetermined length of track jump.

Next, the controller 7 determines whether the music track to which the optical pickup 2 is moved (the destination music track) is different from the music track that was reproduced before the movement. If the controller 7 determines that the destination music track is different from the music track that was reproduced before the movement, the controller 7 controls the motor 3 for optical pickup movement to move the optical pickup 2 to the head of the music track subsequent to the music track that was reproduced before the movement. The music track different from the music track that was reproduced before the movement corresponds to the music track subsequent to the music track that was reproduced before the movement.

Specifically, when the optical pickup 2 reproduces the n−th (n denotes a integer of one or more) music track, as shown in FIG. 6a, the controller 7 determines the absolute time of the position where the optical pickup 2 currently reproducing the information and the music track number (the n−th music track) from the subcodes and so on. The controller 7 recognizes that a scratch is made on the optical disc 10 from the read error signal received from the DSP 6.

When the controller 7 recognizes that the scratch is made on the optical disc 10, the controller 7 controls the motor 3 for optical pickup movement to move the optical pickup 2 toward the outer side of the optical disc 10 by a predetermined length of track jump in order to avoid the scratch made on the optical disc 10, as shown in FIG. 6B. The controller 7 then determines the absolute time and the music track number of the destination from the subcodes and so on. The controller 7 determines whether the music track to which the optical pickup 2 is moved is different from the music track that was reproduced before the movement (whether the music track to which the optical pickup 2 is moved is the n+1−th music track). Since the controller 7 actually moves the optical pickup 2, the controller 7 can read the subcodes.

If the controller 7 determines that the music track to which the optical pickup 2 is moved (the n+1−th music track) is different from the music track that was reproduced before the movement (the n−th music track), the controller 7 controls the motor 3 for optical pickup movement to move the optical pickup 2 to the head of the subsequent music track (the n+1−th music track), as shown in FIG. 6C.

The operation of the disc player 1 and a method of reproducing information on the optical disc 10 in the disc player 1, according to the second embodiment, will now be described. FIG. 7 is a flowchart showing the operation of the disc player 1 and the method of reproducing information on the optical disc 10 in the disc player 1, according to the second embodiment. In Step S11, with the information on the optical disc 10 being reproduced in the disc player 1, the controller 7 determines whether a read error signal is received from the DSP 6.

If the controller 7 determines that the read error signal is not received from the DSP 6 (the determination is negative in Step S11), then in Step S12, the controller 7 determines whether the reproduction of the information on the optical disc 10 terminates in the disc player 1.

If the controller 7 determines that the reproduction of the information on the optical disc 10 terminates (the determination is affirmative in Step S12), the process ends. If the controller 7 determines that the reproduction of the information on the optical disc 10 does not terminate (the determination is negative in Step S12), the controller 7 goes back to Step S11.

If the controller 7 determines that the read error signal is received from the DSP 6 (the determination is affirmative in Step S11), then in Step S13, the controller 7 controls the motor 3 for optical pickup movement to move the optical pickup 2 toward the outer side of the optical disc 10 by a predetermined length of track jump.

In Step S14, the controller 7 determines whether the music track that was reproduced before the movement is different from the music track to which the optical pickup 2 is moved. If the controller 7 determines that the music track that was reproduced before the movement is the same as the music track to which the optical pickup 2 is moved (the determination is negative in Step S14), the controller 7 goes back to Step S11 while continuing the reproduction of the information on the optical disc 10.

If the controller 7 determines that the music track that was reproduced before the movement is different from the music track to which the optical pickup 2 is moved (the determination is affirmative in Step S14), then in Step S15, the controller 7 sets the destination to the head of the music track subsequent to the music track that was reproduced before the movement. In Step S16, the controller 7 controls the motor 3 for optical pickup movement to move the optical pickup 2 to the destination set in Step S15. The controller 7 goes back to Step S11 while continuing the reproduction of the information on the optical disc 10.

As described above in detail, according to the second embodiment, when the controller 7 receives the read error signal, the controller 7 controls the motor 3 for optical pickup movement to move the optical pickup 2 by the distance corresponding to a predetermined time. The controller 7 determines whether the music track before the movement is different from the destination music track. If the controller 7 determines that the music track before the movement is different from the destination music track, the controller 7 controls the motor 3 for optical pickup movement to move the optical pickup 2 to the head of the music track subsequent to the music track before the movement. Accordingly, when the optical pickup 2 is moved to the subsequent music track where the information on the optical disc 10 is reproduced with a scratched portion being skipped, the information is reproduced from the head of the subsequent music track. As a result, the entire music track having no scratch can be reproduced, thus allowing the user to comfortably listen to the music information.

According to the second embodiment, since the controller 7 actually moves the optical pickup 2 to determine whether the destination music track is different from the music track before the movement when the information on the optical disc 10 is reproduced with a scratched portion being skipped, there is no need to perform a complicated calculation and, therefore, the load on the controller 7 can be reduced.

In addition, according to the second embodiment, since the subcodes are used to determine whether the destination music track is different from the music track before the movement, the optical pickup 2 can be moved even if the lead-in area where the TOC is recorded on the optical disc 10 has a scratch.

Although the optical pickup 2 is moved based on the absolute time of the head of the music track set as the destination in the first and second embodiments, the present invention is not limited to this case. For example, the P subcode, indicating the head of the music track, in the subcodes may be used to move the optical pickup 2 to the head of the destination music track. Alternatively, the Q subcode, indicating the elapsed time of the music track, in the subcodes may be used to move the optical pickup 2 backward by the distance corresponding to the elapsed time of the music track to cause the optical pickup 2 to reach the head of the destination music track.

Although the optical disc is used as the recording medium recording the content, and the content is the music information and a plurality of blocks is music tracks in the first and second embodiments, the present invention is not limited to these cases. A magneto-optical disc (for example, a minidisc (MD)) may be used as the recording medium recording the content. The content may be video information and the plurality of blocks may be titles or chapters.

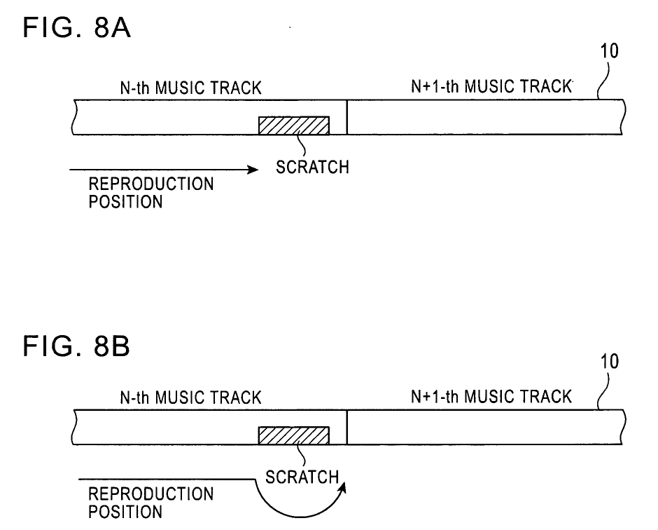

Although the controller 7 determines whether the destination music track is beyond the head of the subsequent music track, when the optical pickup 2 is moved by the distance corresponding to a predetermined time, to control the movement of the optical pickup 2 in the first embodiment, the present invention is not limited to this example. For example, when the controller 7 receives the read error signal in the reproduction of the n−th music track by the optical pickup 2, as shown in FIG. 8A, the controller 7 may determine whether the remaining reproduction time of the n−th music track is shorter than a predetermined time (for example, three to ten seconds). If the controller 7 determines that the remaining reproduction time of the n−th music track is shorter than the predetermined time, the controller 7 controls the motor 3 for optical pickup movement to move the optical pickup 2 to the head of the n+1−th music track, as shown in FIG. 8B.

Although the predetermined time is equal to the reproduction time (for example, three to ten seconds) of the recording track, corresponding to a predetermined length of track jump, the present invention is not limited to this meaning. For example, the predetermined time may be longer (for example, five to twelve seconds) than the reproduction time of the recording track, corresponding to the predetermined length of track jump. In this case, if the remaining reproduction time of the n−th music track is slightly longer (for example, four to eleven seconds) than the reproduction time of the recording track, corresponding to the predetermined length of track jump, the controller 7 determines that the remaining reproduction time of the n−th music track is shorter than the predetermined time because the predetermined time is set so as to be longer than the remaining reproduction time of the n−th music track. The controller 7 controls the motor 3 for optical pickup movement to move the optical pickup 2 to the head of the n+1−th music track. The music information is reproduced from the head of the n+1−th music track without the n−th music track being incompletely reproduced, so that the user can comfortably listen to the music information.

Although the music information is reproduced from the head of the first music track when the set destination of the optical pickup 2 is beyond the head of the lead-out area in the first embodiment, the present invention is not limited to this case. For example, the reproduction of the music information on the optical disc 10 may be terminated when the set destination of the optical pickup 2 is beyond the head of the lead-out area.

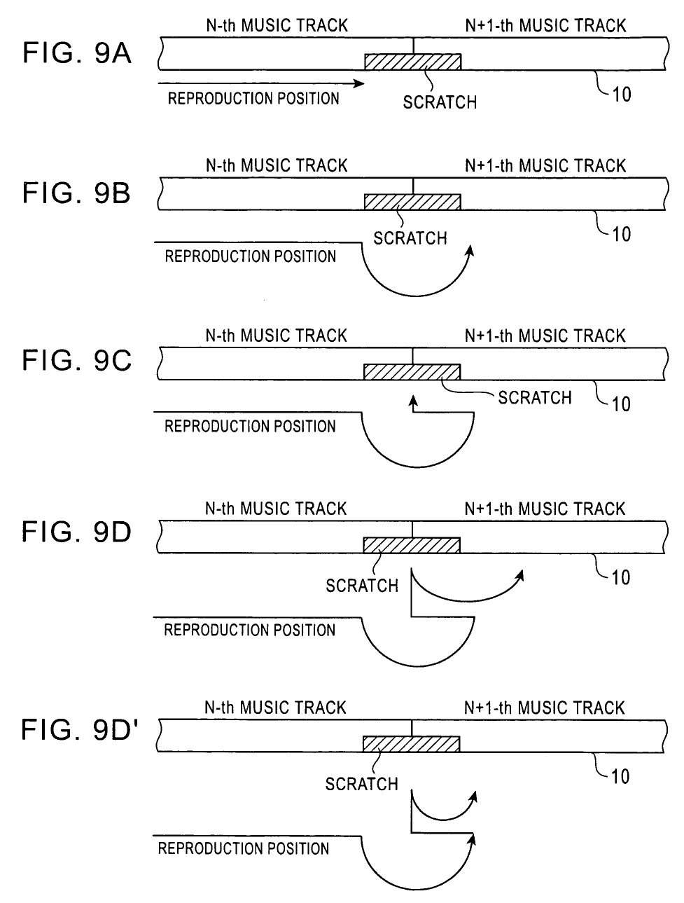

Although the optical pickup 2 is moved to the head of the music track when the destination music track is different from the music track before the movement in the first and second embodiments, an operation shown in FIGS. 8ato 9D′ may be performed when a scratch is made at the head of the destination music track. When a scratch on the optical disc 10 is detected in the reproduction of the music information of the n−th music track, as shown in FIG. 8a, the controller 7 controls the motor 3 for optical pickup movement to move the optical pickup 2 by a predetermined length of track jump, as shown in FIG. 9B.

The controller 7 then determines whether the destination music track (the n+1−th music track) is different from the music track that was reproduced before the movement (the n−th music track). If the controller 7 determines that the destination music track is different from the music track that was reproduced before the movement, the controller 7 controls the motor 3 for optical pickup movement to move the optical pickup 2 to the head of the n+1−th music track, as shown in FIG. 9C. If a scratch is made also at the head of the n+1−th music track, the controller 7 detects the scratch from the read error signal received. In this case, the controller 7 controls the motor 3 for optical pickup movement to move the optical pickup 2 again by the predetermined length of track jump, as shown in FIG. 9D.

Since the n+1−th music track is significantly jumped from its head in the example in FIG. 9D, the controller 7 may reproduce the music information from the position (shown in FIG. 9B) to which the optical pickup 2 is initially moved, as shown in FIG. 9D′.

Although the absolute time and the music track number of the destination of the optical pickup 2 are determined from the subcodes in the second embodiment, the present invention is not limited to this case. For example, the absolute time and the music track number of the destination of the optical pickup 2 may be determined from the TOC recorded in the lead-in area. Alternatively, both the TOC and the subcodes are used to determine the absolute time and the music track number of the destination of the optical pickup 2, instead of using either the TOC or the subcodes. Using both the TOC and the subcodes allows the optical pickup 2 to be moved even when either the TOC or the subcodes cannot be read.

It will be further understood by those skilled in the art that the foregoing description is of the preferred embodiments of the present invention and that various changes and modifications may be made to the invention without departing from the spirit and scope thereof.

The present invention is useful for a disc player uses an optical pickup to read information recorded on that is rotated and driven.

What is claimed is:

1. A disc player that reproduces information in a plurality of blocks sequentially provided on a disc, the disc player comprising:
an optical pickup operable to read the information recorded on a first block of the disc;
a moving unit operable to move the optical pickup for a predetermined period of time when the optical pickup is no longer able to read the information recorded on the first block; and
a controller operable to direct the moving unit to move the optical pickup to the head of a second block subsequent to the first block if the portion of the disc to which the optical pickup will reach after being moved for the predetermined time is within the second block.

2. The disc player according to claim 1, wherein the controller is operable to determine the position that the optical pickup will reach by being moved for the predetermined time, and the controller is operable to control the moving unit to move the optical pickup directly to the head of the second block if the position determined is beyond the head of the second block.

3. The disc player according to claim 2, wherein the controller is operable to determine whether the position that the optical pickup will reach by being moved for the predetermined time is beyond the head of the second block based upon a table of contents recorded on the disc.

4. The disc player according to claim 3, wherein the disc is a compact disc, and the first and second blocks are tracks on the compact disc.

5. The disc player according to claim 2, wherein the controller is operable to determine whether the position that the optical pickup will reach by being moved for the predetermined time is beyond the head of the second block based upon subcodes recorded on the disc.

6. The disc player according to claim 1, wherein the controller is operable to control the moving unit to actually move the optical pickup by a distance corresponding to a predetermined time when the optical pickup is not able to read the information recorded on the disc, and the controller is operable to control the moving unit to subsequently move the optical pickup to the head of the second block if the position to which the optical pickup actually moved was beyond the head of the second block.

7. The disc player according to claim 6, wherein the disc is a compact disc, and the first and second blocks are tracks on the compact disc.

8. The disc player according to claim 1, wherein the controller is operable to acquire a remaining reproduction time of the first block when the optical pickup is no longer able to read the information recorded on the first block of the disc, and the controller is operable to control the moving unit to move the optical pickup to the head of the second block if the remaining reproduction time is less than the predetermined period of time.

9. The disc player according to claim 8, wherein the controller is operable to acquire the remaining reproduction time of the first block based upon a table of contents recorded on the disc.

10. The disc player according to claim 9, wherein the disc is a compact disc, and the first and second blocks are tracks on the compact disc.

11. The disc player according to claim 8, wherein the controller is operable to acquire the remaining reproduction time of the first block based upon subcodes recorded on the disc.

12. A method of reproducing information in a plurality of blocks sequentially provided on a disc, the method comprising:
determining a position where an optical pickup will reach in a predetermined time when the optical pickup is not able to read the information recorded on a first block of the disc;
determining whether the position is beyond the head of a second block subsequent to the first block; and
moving the optical pickup to the head of the second block if it is determined that the position is beyond the head of the second block.

13. The method according to claim 12, wherein the determination of whether the position is beyond the head of the second block subsequent to the first block is based upon a table of contents recorded on the disc.

14. The method according to claim 13, wherein the disc is a compact disc, and the first and second blocks are tracks on the compact disc.

15. The method according to claim 12, wherein the determination of whether the position is beyond the head of the second block subsequent to the first block is based upon subcodes recorded on the disc.

16. The method of claim 12, comprising moving the optical pickup to the position before subsequently moving the optical pickup to the head of the second block.

17. A method of reproducing information in a plurality of blocks sequentially provided on a disc, the method comprising:
moving an optical pickup by a distance corresponding to a predetermined time when the optical pickup is not able to read the information recorded on a unreadable portion of the disc;
determining whether a block to which the optical pickup has been moved to includes the unreadable portion of the disc; and
moving the optical pickup to the head of the block to which the optical pickup has been moved if it is determined that the block does not include the unreadable portion of the disc.

18. The method according to claim 17, wherein the optical pickup is moved by the distance corresponding to the predetermined time based upon subcodes recorded on the disc.

19. The method according to claim 18, wherein the disc is a compact disc, and the block is a track on the compact disc.

20. The method according to claim 17, wherein the optical pickup is moved by the distance corresponding to the predetermined time based upon a table of contents recorded on the disc.
